(19) United States
(12) Patent Application Publication
(10) Pub. No.: US 2004/0233892 A1
(43) Pub. Date: Nov. 25, 2004

(54) Priority caller alert

(76) Inventors: Linda Ann Roberts, Decatur, GA (US); Edward Michael Silver, Atlanta, GA (US)

Correspondence Address: BAMBI FAIVRE WALTERS, PO BOX 5743, WILLIAMSBURG, VA, 23188, US

(21) Appl. No.: 09/855,804

(22) Filed: May 16, 2001

(51) Int. Cl. H04L 12/66

(52) U.S. Cl. 370/352

(57) ABSTRACT

A method for alerting a subscriber when a call intended for a telephone line of the subscriber is received from a priority caller. When the call from the priority caller is detected, the preferred embodiment of the present invention can perform one or more priority actions, including (1) ringing a telephone associated with the telephone line with a priority alert signal that is different from a regular ringing tone; (2) generating an outgoing call to another telephone associated with a second telephone line of the subscriber; (3) generating an outgoing call to a wireless telephone of the subscriber via a wireless telephone network; and (4) establishing a communication session with a computer associated with the subscriber via a computer network. The communication session may be a voice-over-Internet protocol (VoIP) call. At least two methods can be used to determine whether a calling party is a priority caller. First, the telephone number of the priority caller is associated with the subscriber number of the telephone line in a database. Second, the calling party is required to provide a priority code that has been associated with the subscriber number in the database.

### BACKGROUND

1. Field of the Invention

The present invention relates to telecommunications, and more particularly, to a system and method for alerting a subscriber when a call from a priority caller is received.

2. Background of the Invention

An increasing number of people are using two or more telephone lines on any given day. A typical telephone user in an industrialized nation can have three telephone lines dedicated for him or her. For example, the user has a first telephone line at his or her residence, a second line for the office, and a wireless communication link (the third line) associated with a wireless telephone that the user carries around. Although multiple telephone lines can provide the user with additional convenience, they do not solve all problems related to how the user may wish to manage his or her incoming calls. For example, if the user is expecting an important telephone call to the user's home telephone, but the user must leave the home due to an unexpected situation, the user would have missed that important call.

A user, under currently available telecommunications technologies, can do one of several things to make sure that he or she does not miss that important call. For example, with an appropriate subscription or arrangement with his or her telephone service provider, the user can activate a call forwarding feature of the home telephone.

The call forwarding service allows a subscriber to answer a call at a telephone different from the telephone for which the call was intended. For example, a telephone customer with a subscription to a call forwarding service can receive a call intended for the subscriber's home telephone at any location the subscriber desires as long as the subscriber remembers to activate the call forwarding service by supplying a forwarding telephone number.

A typical example of call forwarding involves a subscriber providing his wireless telephone number as the forwarding telephone number so that all calls intended for his home telephone would be forwarded to his wireless telephone. This solution, however, creates unexpected new problems.

For example, if the subscriber, having activated the call forwarding service, returns home without deactivating the call forwarding service and having his or her wireless telephone turned off, the subscriber will not be able to receive any calls. Furthermore, even if the subscriber stays home with the wireless telephone turned on, the subscriber would be answering a telephone call intended for the wireline telephone using the wireless telephone. In this situation, the subscriber would be paying a higher wireless telephone bill due to the higher rates associated with wireless services. Other problems related to increased cost and inconvenience exist.

Attempts have been made to solve the above problems by providing simultaneous ringing services to multiple telephones of a customer. For example, U.S. Pat. No. 5,206,901 (Harlow) discloses a system for alerting multiple telephones in response to an incoming call to a subscriber's primary telephone. U.S. Pat. No. 5,502,762 (Andrew) discloses a telephone device that, in addition to routing the call to a first telephone, generates additional calls to one or more additional telephones. U.S. Pat. No. 5,802,160 (Kugell) discloses a method in which a telephone service subscriber has greater flexibility in the management of the multiple telephones receiving simultaneous ringing services. U.S. Pat. No. 5,206,901 (Harlow), U.S. Pat. No. 5,502,762 (Andrew), and U.S. Pat. No. 5,802,160 (Kugell) are hereby incorporated by reference in their entirety.

The state of the art, as described in the above-identified patents, utilizes valuable telecommunication resources because multiple calls are initiated regardless of whether an incoming call is a priority call. In other words, conventional call alerting services generate multiple outgoing calls each time an incoming call is received, regardless of whether the calling party is a priority caller. As a result, three ports are tied up when two simultaneous calls are initiated even when the incoming call is not a priority call.

Accordingly, there is a need for a system and method that can determine whether an incoming call for a subscriber is from a priority caller, and that can forward only calls from priority callers to the subscriber at one or more telephones.

### SUMMARY OF THE INVENTION

The present invention is a system and method that can first determine whether an incoming call is from a priority caller. A system of the present invention can be adapted to perform a number of different actions if the call is from a priority caller. Three exemplary sets of actions are provided below for illustration purposes.

(1) Do not terminate the call to any of the subscriber's telephones (i.e., do not alert the subscriber) if the call is not from a priority caller; and terminate the call to the telephone (i.e., alert the subscriber) with a regular ringing tone if the call is from a priority caller.

(2) Terminate the call to the subscriber's designated telephone with a regular ringing tone if the call is not from a priority caller; and terminate the call to the telephone with a priority alert signal if the call is from a priority caller. The priority alert signal may be, for example, an auditory signal such as a tone. The priority alert signal may also be, for example, an earcon (musical sound). Furthermore, the priority alert signal may be, for example, a speech segment such as: “A priority call is waiting.”

(3) Terminate the call to the subscriber's designated telephone with a regular ringing tone if the call is not from a priority caller; and terminate the call to the telephone with a priority alert signal if the call is from a priority caller; and further alerting the subscriber to the call via at least one additional communication session.

The additional communication session can be established using a number of different methods. First, the additional communication session may be a new call to a different telephone designated by the subscriber. For example, the different telephone may be a wireless telephone or a wireline telephone. Second, the additional communication session may be a voice-over-Internet Protocol (VoIP) call to a computer associated with the subscriber. Third, the additional communication session may be a text or voice message transmitted to other devices as designated by the subscriber. For example, an e-mail or a short voice message can be sent to the subscriber's pager or personal digital assistant.

### BRIEF DESCRIPTION OF THE DRAWINGS

FIG. 1 is a schematic diagram showing the system architecture of an embodiment of the present invention.

FIG. 2 is a flowchart illustrating the steps involved in using an embodiment of the present invention.

FIG. 3 is a schematic diagram showing the system architecture of a first preferred embodiment of the present invention implemented in an Advanced Intelligent Network (AIN).

FIG. 4 is a flowchart illustrating the steps involved in using the first preferred embodiment of the present invention.

FIG. 5 is a schematic diagram showing the system architecture of a second preferred embodiment of the present invention involving an AIN and a computer network.

FIG. 6 is a flowchart illustrating the steps involved in using the second preferred embodiment of the present invention.

### DETAILED DESCRIPTION OF PREFERRED EMBODIMENTS

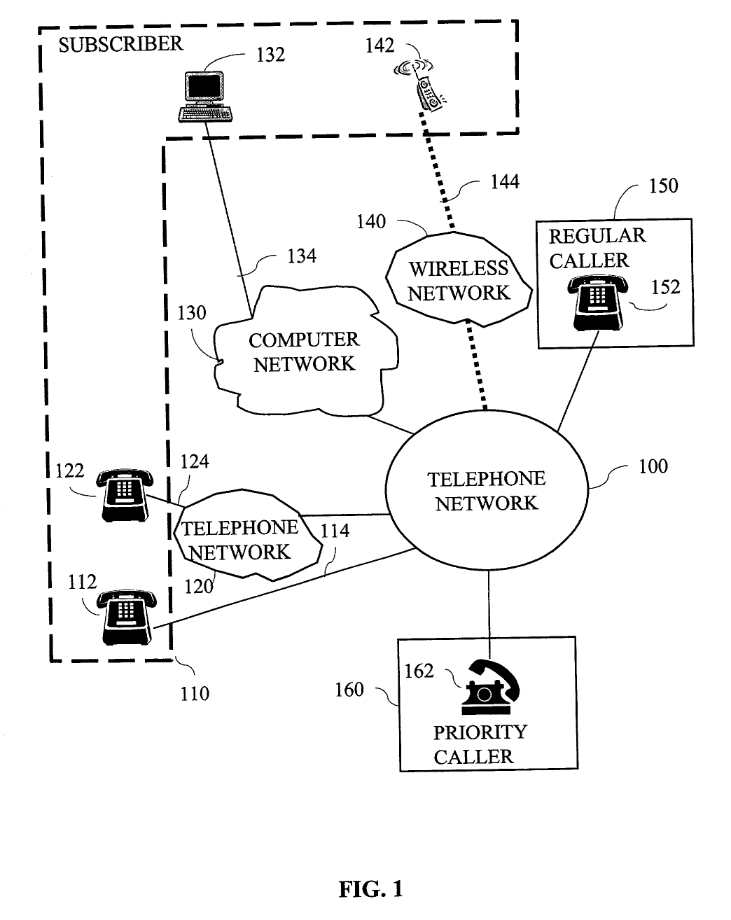

FIG. 1 is a schematic diagram showing the general system architecture of an embodiment of the present invention. Telephone network 100 provides a service according to the present invention to telephone line 114 of subscriber 110. Subscriber 110 can initiate and accept calls through telephone network 100 using equipment 112 via telephone line 114. Telephone network 100 can be a wireline network. For example, telephone network 100 may be a network operated by a local exchange carrier. Although telephone network 100 is depicted and described herein as a wireline telephone network, telephone network 100 can be a wireless telephone network. For example, telephone network 100 can be a wireless intelligent network, in which telephone line 114 is a wireless connection and equipment 112 is a wireless device with wireless communication capabilities.

In addition to equipment 112, subscriber 110 may have equipment 122, computer 132, and wireless device 142. Equipment 122 is a wireline telephone located, for example, in subscriber 110's vacation home. Equipment 122 communicates with telephone network 100 via telephone line 124 and telephone network 120. Telephone line 124 is part of telephone network 120. Telephone network 120 could be the same network as telephone network 100.

Computer 132 communicates with telephone network 100 via connection 134 and computer network 130. Connection 134 may comprise one or more of a dial-up connection, an ISDN line, a DSL, a T1 line, a T3 line, a cable modem line, or any other connection that can facilitate a communication session between computer 132 and computer network 130. Computer network 130 may, for example, be connected to or comprise the well known Internet, or it could be a local area network (LAN) or wide area network (WAN). Computer 132 may be adapted to communicate using VoIP and the Transmission Control Protocol/Internet Protocol (TCP/IP), as known in the art.

Wireless device 142 communicates with telephone network 100 via wireless connection 144 of wireless network 140. Although depicted as a wireless telephone, wireless device 142 can be any wireless device with telecommunications capabilities. For example, wireless device 142 can be a pager, a personal digital assistant, or a pocket PC.

Equipment 152 associated with regular caller 150, and equipment 162 associated with priority caller 160, can communicate with telephone network 100 via a wireline or a wireless network (not shown in FIG. 1), depending on whether equipment 152 and 162 are wireline or wireless devices.

Subscriber 110 can use one or more of equipment 112, equipment 122, computer 132, and wireless device 142 to initiate or receive communications to or from regular caller 150 (on equipment 152) and priority caller 160 (on equipment 162). Similarly, regular caller 150 and priority caller 160 can initiate or receive communication sessions to or from subscriber 110 (on equipment 112, equipment 122, computer 132, or wireless device 142).

In one embodiment of the present invention, when regular caller 150 dials a telephone number associated with telephone line 114 (the subscriber number), equipment 112 does not ring and regular caller 150 hears an announcement that subscriber 110 is not available to answer the call. When priority caller 160 dials the same subscriber number, however, equipment 112 rings and subscriber 110 is alerted.

In another embodiment of the present invention, when regular caller 150 dials the subscriber number, equipment 112 rings with a regular ringing tone if telephone line 114 is not already in use. When priority caller 160 dials the subscriber number, equipment 112 rings with a priority alert signal rather than a regular ringing tone. Accordingly, the priority alert signal may be one that which uses the method disclosed in U.S. Pat. No. 4,995,075, which is incorporated herein by reference in its entirety. Alternatively, the priority alert signal may be an earcon or a recorded speech segment.

In another embodiment of the present invention, when priority caller 160 dials the subscriber number, one or more of equipment 112, equipment 122, computer 132, and wireless device 142 can be notified about the call. For example, in addition to or in lieu of simply ringing equipment 112, equipment 122 can also ring. Furthermore, a pop-up window can appear on the screen of computer 132 alerting subscriber 110 about the call. Similarly, wireless device 142 can ring or vibrate to indicate that a priority call has been received.

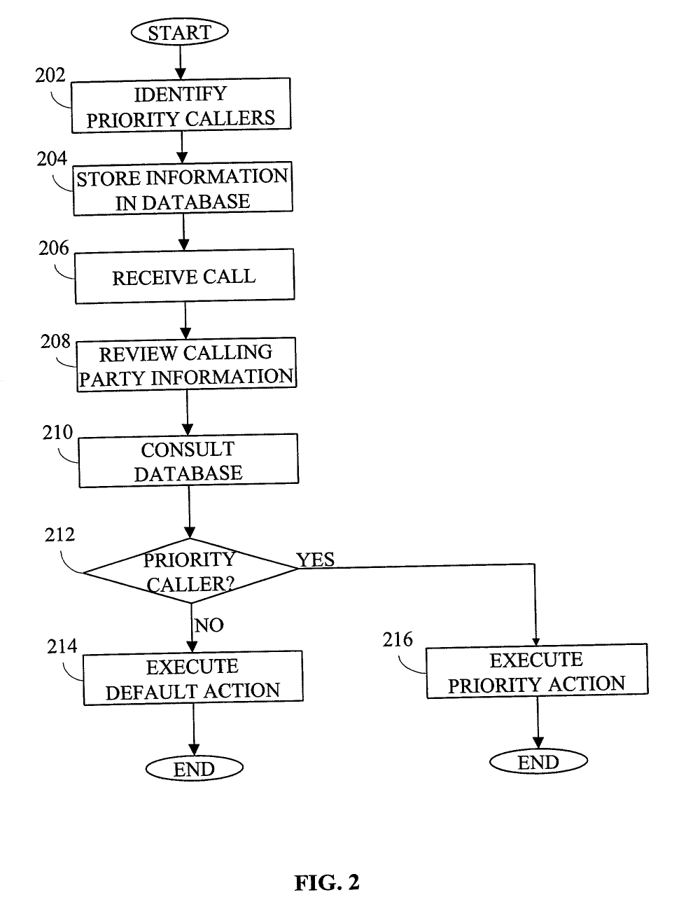

FIG. 2 is a flowchart illustrating the steps involved in using an embodiment of the present invention. In step 202, subscriber 110 identifies at least one priority caller. For example, priority caller 160 may be identified as the priority caller. Priority caller 160 may be a family member, a close friend or relative, or another person from whom subscriber 110 expects an important call that subscriber 110 does not want to miss.

In step 204, priority caller information related to priority caller 160 is stored in a database associated with telephone network 100. The priority caller information may comprise priority caller 160's telephone number that is associated with telephone line 162. Alternatively, or additionally, the priority caller information may comprise a password or personal identification number (PIN) (the priority code) used to identify priority caller 160. In this case, subscriber 110 must provide the priority code to priority caller 160 to use the present invention. The priority caller information can further include, for example, instructions related to how incoming calls from priority caller 160 should be processed.

In step 206, when a calling party or a caller (e.g., one of regular caller 150 and priority call 160 ) places a call to the telephone number associated with telephone line 114 (the subscriber number), the call is received by telephone network 100. As known to one of ordinary skill in the art, the call signaling can comprise calling party information, such as, for example, the telephone number of the telephone line that is used by the caller to initiate the call (the calling party number). The calling party information may also comprise a priority code manually entered by the caller.

In step 208, telephone network 100 reviews the calling party information to determine whether the caller is a priority caller and how the call should be processed. In step 210, telephone network 100 consults the database in which priority caller information is stored. If it is determined in step 212 that the caller information does not match the priority caller information stored in the database, i.e., the call is not from priority caller 160, the process goes to step 214. Otherwise, if the call is from priority caller 160, the process goes to step 216.

In step 214, telephone network 100 executes a default action. The default action may be one of several actions available to telephone network 100. For example, telephone network 100 can play an announcement for the caller that subscriber 110 is not available to take the call. Alternatively, telephone network 100 can ring equipment 112 with a regular ringing tone.

In step 216, telephone network 100 executes a priority action. The priority action can be one or more of the following:

(a) ring equipment 112 with a regular ringing tone if the default action in step 214 is to play an announcement;

(b) ring equipment 112 with a priority alert signal if the default action in step 214 is to play a regular ringing tone;

(c) notify equipment 122 about the call via telephone network 120;

(d) notify computer 132 about the call via computer network 130, and

(e) notify wireless device 142 about the call via wireless network 140.

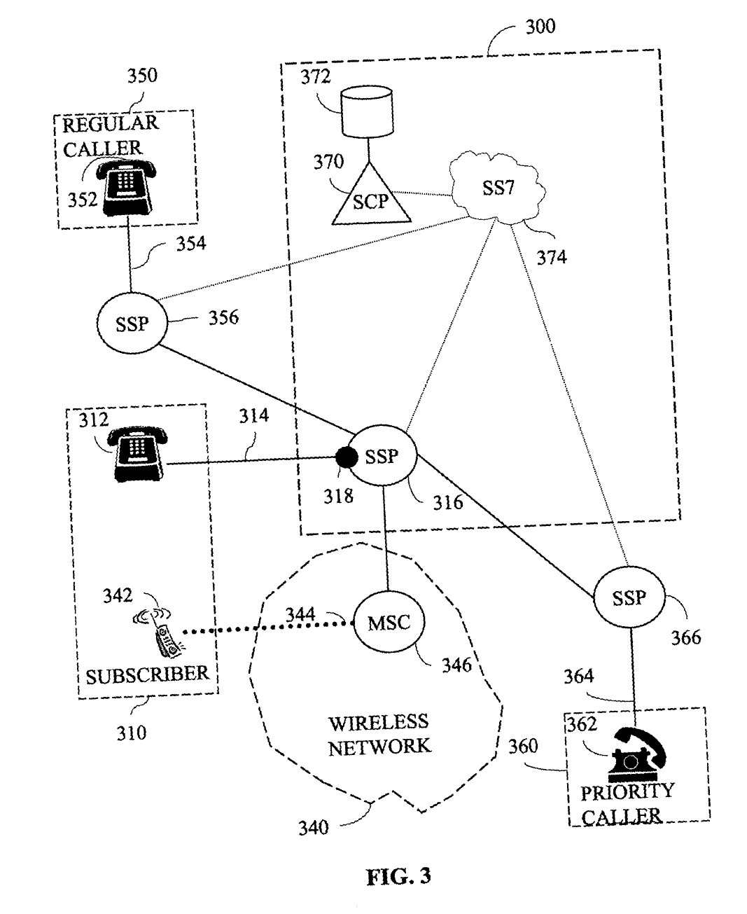

FIG. 3 is a schematic diagram showing the system architecture of a first preferred embodiment of the present invention implemented in an Advanced Intelligent Network (AIN). The AIN architecture is described in U.S. Pat. Nos. 5,701,301, and 5,838,774, which are hereby incorporated by reference in their entirety.

Telephone network 300 is an AIN and the service provider of the present invention. Subscriber 310 is a customer of AIN 300 and a service subscriber of the present invention. Subscriber 310 has customer premises equipment (CPE) 312. CPE 312 may be a telephone set, or other device capable of establishing communication sessions (i.e., initiate and receive calls) through telephone line 314. The telephone number associated with telephone line 314 is hereinafter referred to as the subscriber number. Telephone line 314 is connected to service switching point (SSP) 316. Subscriber 310 also has wireless telephone 342. Wireless telephone 342 is part of wireless network 340. Wireless telephone 342 can effect wireless communication sessions with AIN 300 via wireless connection 344 and mobile switching center (MSC) 346 of wireless network 340.

One or more AIN triggers for telephone line 314 may be provisioned on SSP 316. For example, trigger 318 may be a termination attempt trigger (TAT), a terminating busy/no answer trigger, or other AIN triggers associated with telephone line 314. Trigger 318 interrupts all incoming calls intended for subscriber 310. For example, when regular caller 350 uses CPE 352 associated with telephone line 354 to call the subscriber number, trigger 318 detects the call and causes SSP 316 to determine how the call should be processed. Similarly, trigger 318 will detect and interrupt calls from priority caller 360 when priority caller 360 uses CPE 362 of telephone line 364 to call the subscriber number.

For purposes of illustration, SSP 356 and SSP 366 are shown as being outside AIN 300. However, either or both of SSP 356 and SSP 366 may be an SSP on telephone network 300, and may even be SSP 316. Similarly, for illustration purposes, regular caller 350 and priority caller 360 are shown to be customers of a wireline network. One or both of them could be a customer of a wireless network, in which case equipment 352 and/or equipment 362 would be a wireless device.

The detection of an incoming call by trigger 318 causes SSP 316 to launch an AIN query. The query launched by SSP 316 is sent to service control point (SCP) 370 over the AIN's signaling network 374. In a preferred embodiment, signaling network 374 uses the Common Channel Signaling System Number 7 (SS7). The query comprises the subscriber number in a Called_Party_ID field of the query. In addition, the query comprises the calling party's number in the Calling_Party_ID field. If the caller is regular caller 350, the Calling_Party_ID field will comprise the telephone number of regular caller 350, i.e., the telephone number associated with telephone line 354. Similarly, if the caller is priority caller 360, this field will comprise the telephone number associated with telephone line 364.

SCP 370 uses the subscriber number to access a subscriber list associated with subscriber 310. The subscriber list may be retrieved from database 372. Database 372 is preferably directly accessible to SCP 370. Alternatively, database 372 can be on a different computer system in communication with SCP 370. The subscriber list comprises priority caller information such as telephone numbers and/or PINs of priority callers that subscriber 110 has previously identified. For example, the subscriber list comprises the telephone number of priority caller 360.

Using the subscriber number, SCP 370 can retrieve one or more call processing instructions from database 372. The call processing instructions can be one of several instructions from SCP 370 to SSP 316 regarding how calls received by SSP 316 should be handled. The instructions provided by SCP 370 to SSP 316 are in the form of a response to the query.

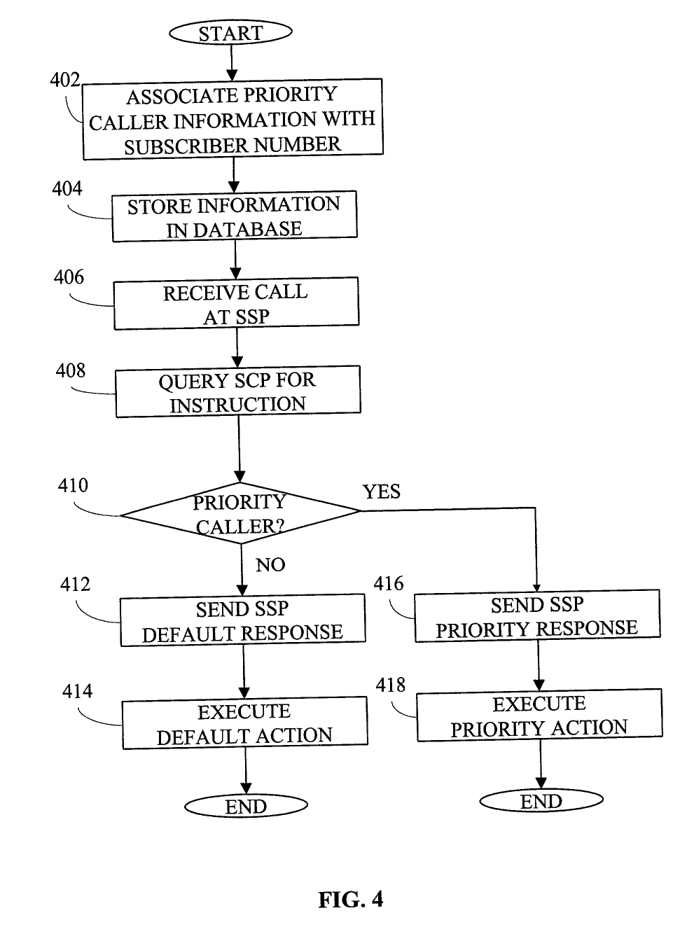

FIG. 4 is a flowchart illustrating exemplary steps for using the first preferred embodiment of the present invention. With a subscription to a service of the present invention, a call from priority caller 360 intended for telephone line 314 can be received by subscriber 310 using wireless telephone 342 in addition to CPE 312.

In step 402, the subscriber number of subscriber 310 is associated with priority caller information. The priority caller information may comprise, for example, the telephone number of priority caller 360. For illustration purposes, the subscriber number is “314-314-3333,” and the telephone number associated with telephone line 364 of priority caller 360 is “364-364-6666.”

In step 404, the priority caller information and the subscriber number are stored in database 372. Additionally, database 372 can contain information regarding a priority alert signal that is associated with the subscriber number. Preferably, the relationship between the subscriber number, the priority caller information, and the priority alert signal can be stored in a subscriber list or a table, such as, for example, Table 1 below.

TABLE 1

| | | Priority |
|---|---|---|
| | Priority Caller | Alert |
| Subscriber Number | Number | Signal |
| 314-314-3333 | 364-364-6666 | A |

Priority Alert Signal A could be, for example, a short fast high-pitched beeping signal. Although only one priority caller number and only one priority alert signal are shown in Table 1, subscriber number “314-314-3333” can be associated with a plurality of priority caller numbers and a plurality of priority alert signals.

In step 406, when an incoming call from a caller arrives at SSP 316, the call is detected by trigger 318. Trigger 318 is preferably a TAT.

In step 408, SSP 316 launches a query to SCP 370. The query may be, for example, an Info_Analyze query. The query comprises “314-314-3333” in the Called_Party_ID field. In addition, the query comprises the telephone number associated with the telephone line used by the caller to generate the incoming call. For example, if the call is generated using telephone line 364, then “364-364-6666” would be included in the Calling_Party_ID field of the query.

In step 410, SCP 370 determines whether the call is from a priority caller. For example, using information contained in the Called_Party_ID field, i.e., the number “314-314-3333,” SCP 370 retrieves subscriber 310's information from database 372. Specifically, SCP 370 can access data such as found in Table 1. If “364-364-6666” appears in the Calling_Party_ID field of the query, then SCP 370 determines that the caller is a priority caller because this number matches priority caller information in database 372. Otherwise, if the telephone number indicated in the Calling_Party_ID field does not match any priority caller number in Table 1, SCP determines that the incoming call is not from a priority caller.

If SCP 370 recognizes the caller as a priority caller, e.g., the information in the Calling_Party_ID field is “364-364-6666,” the process goes to step 416. Otherwise, if the caller is not a priority caller, e.g., the caller is regular caller 350, the process goes to step 412.

In step 412, SCP 370 sends a default response to SSP 316. The default response may comprise an instruction to execute any suitable action supported by AIN 300. For example, the default response may be an Authorize_Termination message instructing SSP 316 to terminate the call (i.e., complete the call to telephone line 314 ) with a regular ringing tone. Alternatively, the default response may be to play an announcement, informing the caller that subscriber 310 is unavailable. In step 414, SSP 316 executes the default action associated with the default response.

In step 416, if the call is received from a priority caller, e.g., priority caller 360, SCP 370 sends SSP 316 a priority response. The priority response may be an Authorize_Termination message as described above. To distinguish the call as a priority call, the priority response may include, a special code indicating that CPE 112 should play the priority alert signal, for example, in the ControllingLegTreatment field of the Authorize_Termination message. In step 418, SSP 316 causes CPE 112 to play the priority alert signal specified in database 372. For example the priority alert signal may be a short fast high-pitched beeping signal, a recorded speech segment, or other distinguishing signal.

In addition, the priority response of step 416 can comprise an instruction to generate one or more additional communication sessions. For example, the priority response may comprise an instruction for SSP 316 to generate an outgoing call to wireless telephone 342. Generation of the outgoing call in step 418 can be performed using known methods. For example, the outgoing call can be a simultaneous ringing call that can be generated by one of the prior art methods disclosed in the patents incorporated herein by reference.

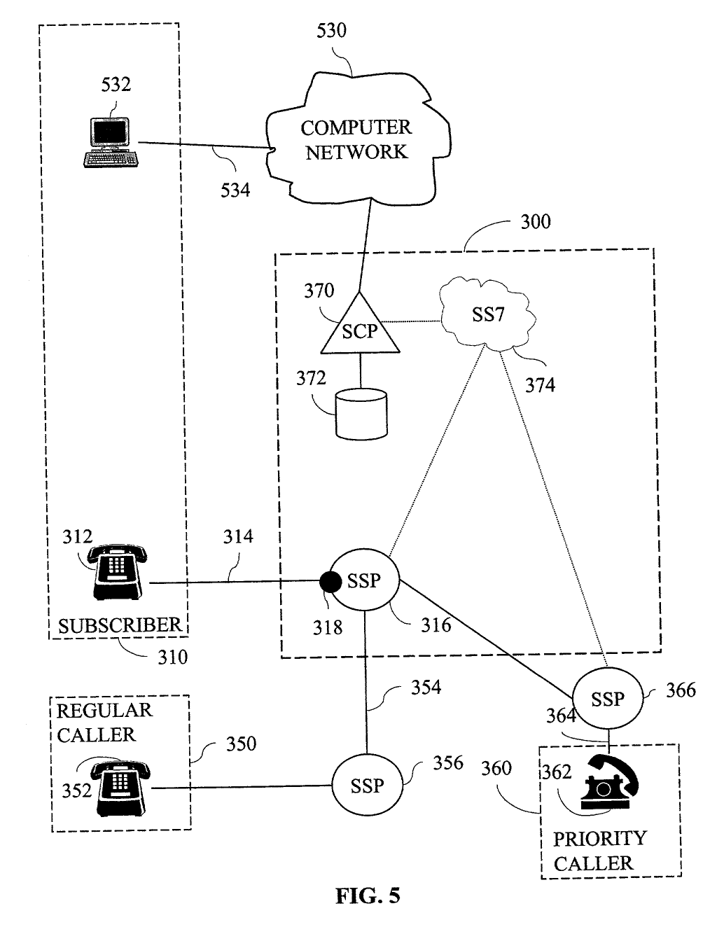

FIG. 5 is a schematic diagram showing the system architecture of a second preferred embodiment of the present invention involving both an AIN and a computer network. In this embodiment, subscriber 310 can be alerted by computer 532 when priority caller 360 calls the subscriber number. Furthermore, subscriber 310 can answer the call with computer 532 using, for example, VoIP.

Computer 532 can be a laptop computer, a desktop computer, or a terminal connected to a local area network. Preferably, computer 532 is adapted to communicate with telephone network 300 via computer network 530. For example, if computer network 530 is the Internet, computer 532 is adapted to communicate using TCP/IP.

The various components associated with AIN 300 for the second preferred embodiment are similar to those described above in the first preferred embodiment. However, SCP 370 of the second preferred embodiment is further adapted to communicate with computer network 530, as shown in FIG. 5. In a specific implementation of the second preferred embodiment, SCP 370 is adapted to communicate with computer network 530 using TCP/IP.

The detection of an incoming call from a calling party by trigger 318 causes SSP 316 to launch a query. The query launched by SSP 316 is sent to SCP 370. The query comprises the subscriber number in the Called_Party_ID field of the query.

SCP 370 then uses the subscriber number to access a subscriber list associated with subscriber 310. The subscriber list may be stored in database 372. Using the subscriber number, SCP 370 retrieves one or more call processing instructions from database 372. The call processing instructions can be one of several instructions from SCP 370 to SSP 316 regarding how calls received by SSP 316 should be handled. For example, a first instruction from SCP 370 may be for SSP 316 to solicit a priority code from the calling party. Depending on whether a priority code is provided and whether the priority code provided is recognized by SCP 370, SCP 370 may issue a second instruction for SSP 316 to terminate the call. Each instruction provided by SCP 370 to SSP 316 is in the form of a response to the query.

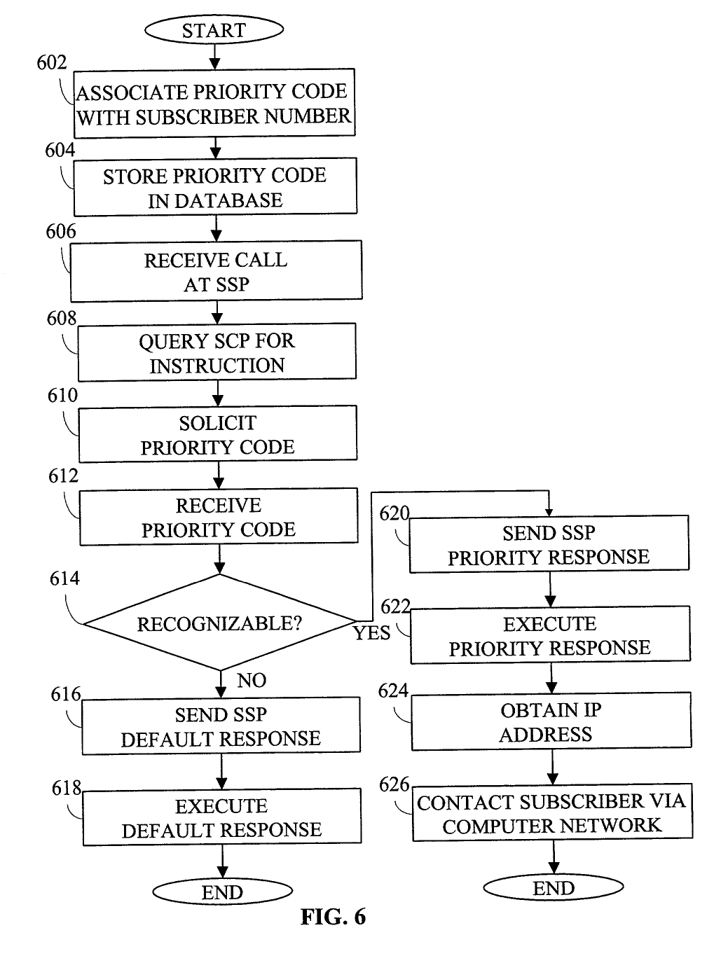

FIG. 6 is an exemplary flowchart illustrating the steps involved in using the second preferred embodiment of the present invention. With a subscription to a service of the present invention, a call from priority caller 360 intended for telephone line 314 can be received by subscriber 310 using computer 532 in addition to CPE 312. Furthermore, in this example, priority caller 360 is not restricted to use telephone line 364 to invoke the priority alert service because the system will request a priority code as described above.

In step 602, the subscriber number of subscriber 310 is associated with priority caller information. The priority caller information may comprise, for example, one or more priority codes. The priority code may be any number that subscriber 310 designates to implement the present invention. The priority code can have any number of digits. Preferably, the priority code has two to six digits. For example, subscriber 310 may designate “8888” as a first priority code and “9999” as a second priority code. One or more of the priority codes must be provided by subscriber 310 to each person for whom subscriber 310 wishes to have priority call treatment.

In step 604, the priority caller information (i.e., the priority codes) and the subscriber number are stored in a database. For example, database 372 connected to SCP 370 may be used to store the priority caller information and the subscriber number. In addition, the database includes information regarding one or more priority alert signals that are associated with the one or more priority codes. Moreover, the network address of computer 532 can be supplied to database 372. The network address may be, for example, an IP address or other address reachable via computer network 530. Preferably, the relationship between the subscriber number, the network address, the priority caller information, and the priority alert signals can be stored in a subscriber list or a table, such as, for example, Table 2 below.

TABLE 2

| | | | Priority |
|---|---|---|---|
| | Network Address | Recognizable | Alert |
| Subscriber Number | of Computer | Priority Codes | Signals |
| 314-314-3333 | 123.45.67.89 | 8888 | A |
| | | 9999 | B |

Priority Alert Signal A may be, for example, a short fast beeping tone. Priority Alert Signal B may be, for example, a long fast beeping tone.

Subscriber number “314-314-3333” can be associated with more than two priority codes. Furthermore, more than one priority code can share a common priority alert signal. Similarly, the subscriber number can be associated with more than one network address.

In step 606, when an incoming call from a calling party arrives at SSP 316, the call is detected by trigger 318. Trigger 318 is preferably a TAT.

In step 608, SSP 316 launches a first query to SCP 370. The first query may be, for example, an Info-Analyzed query. The first query comprises “314-314-3333” in the Called_Party_ID field. In this embodiment, it is not necessary to have any information in the Calling_Party_ID field.

In step 610, SCP 370 sends a first instruction to SSP 316 to solicit a priority code from the caller and return the results to SCP 370. The solicitation may be in the form of an announcement. For example, the announcement may comprise, “Please press or say a priority code if you wish to receive a priority treatment on this call.”

In step 612, if the caller keys in or says one or more numbers, the one or more numbers are interpreted as the priority code from the calling party. If the calling party fails to provide any number within a predetermined amount of time, a default priority code can be generated. The default priority code may be, for example, “0000.”

When the priority code is received from the calling party or when the default priority code is generated, SSP 316 launches a second query to SCP 370. The second query returns the priority code as requested by SCP 370.

In step 614, SCP 370 determines whether the call is from a priority caller. For example, using information contained in the Called_Party_ID field, i.e., the number “314-314-3333,” SCP 370 retrieves subscriber 310's information from database 372. Specifically, SCP 370 can access data such as that shown in Table 2. In this example, if the caller supplied one of “8888” and “9999” as the priority code in step 612, then SCP 370 determines that the call is from a priority caller.

If SCP 370 recognizes the caller as a priority caller, i.e., one of priority codes “8888” and “9999” has been supplied by the caller, the process goes to step 620. Otherwise, if the priority code is not one of “8888” and “9999, ” the process goes to step 616.

In step 616, SCP 370 sends a default response to SSP 316. The default response may comprise an instruction for SSP 316 to execute any suitable action supported by AIN 300. For example, the default response may be to provide a regular ringing tone. Alternatively, the default response may be to forward the call to an answering machine or to voicemail. In step 618, SSP 316 executes a default action associated with the default response. For example, SSP 316 communicates with CPE 312 to play the regular ringing tone.

In step 620, if the call is received from a priority caller, e.g., priority caller 360, SCP 370 sends SSP 316 a priority response. The priority response may be an Authorize_Termination message. The priority response may include, for example, in the ControllingLegTreatment field of the Authorize_Termination message, a special code indicating that CPE 312 should play a priority alert signal associated with the priority code. SSP 316 then communicates with CPE 312 to execute a priority action associated with the priority response. For example, if the priority code provided is “8888,” then Priority Alert Signal A would be played by CPE 312 in step 622. Similarly, if the priority code provided by the calling party is “9999,” then Priority Alert Signal B would be played by CPE 312 in step 622.

Additionally, in this example, the subscriber's service is configured so that computer 532 is notified about the call. This is accomplished in steps 624 and 626. In step 624, SCP 370 obtains the network address of computer 532 from database 372. In step 626, SCP 370 establishes a TCP/IP communication session with computer 532 via computer network 530. In one implementation of the embodiment, a window may appear on the screen of computer 532 to alert subscriber 532 that a priority call for telephone line 314 has been received. In another implementation, subscriber 310 can pick up the call using computer 532, and have a conversation with the priority caller using, for example, VoIP. U.S. Pat. No. 6,141,341, which is incorporated herein by reference in its entirety, discloses a system and method for placing and receiving VoIP calls.

In an embodiment in which the present invention is adapted to screen calls for a wireless telephone service subscriber who is driving, the present invention enables the subscriber to attend to driving and be confident that he or she will not miss important calls from priority callers.

In another embodiment, the present invention can be adapted to send an e-mail notifying subscriber 310 that a priority call has been received. The e-mail could be sent by SCP 370 to, for example, a personal digital assistant or an interactive pager of subscriber 310.

The present invention has numerous embodiments and applications. Each of the embodiments comprises one or more of the steps described above. In addition, each of the embodiments can comprise other steps known to one of ordinary skill in the art to implement the various embodiments. The steps may be implemented in any logical order, i.e., the order is not limited to the order in which the steps are described above or recited in the claims below.

The foregoing disclosure of embodiments of the present invention has been presented for purposes of illustration and description. It is not intended to be exhaustive or to limit the invention to the precise forms disclosed. Many variations and modifications of the embodiments described herein will be obvious to one of ordinary skill in the art in light of the above disclosure. The scope of the invention is to be defined only by the claims appended hereto, and by their equivalents.

What we claim is:

1. A system for routing an incoming call from a calling party for a telephone line of a subscriber comprising:
a service switching point associated with the telephone line; and
a service control point in communication with the service switching point,
wherein when the service switching point detects the incoming call, the service switching point launches a query comprising a subscriber number to the service control point,
wherein when the service control point receives the query, the service control point determines whether the calling party is a priority caller,
wherein the service control point returns a default response to the service switching point if the calling party is not a priority caller, and
wherein the service control point returns a priority response to the service switching point if the calling party is a priority caller.

2. The system of claim 1, wherein the query further comprises priority caller information.

3. The system of claim 2, wherein the priority caller information is a telephone number associated with a second telephone line that is used by the calling party to initiate the incoming call.

4. The system of claim 2, wherein the priority caller information is a priority code supplied by the calling party.

5. The system of claim 1, wherein the default response comprises an instruction for the service switching point to terminate the call using a regular ringing tone and the priority response comprises an instruction for the service switching point to terminate the call using a priority alert signal.

6. The system of claim 1, wherein the priority response comprises an instruction for the service switching point to initiate an outgoing call to another telephone associated with the subscriber.

7. The system of claim 6, wherein the another telephone is a wireless telephone.

8. The system of claim 1, wherein the service control point establishes a communication session with a computer associated with the subscriber via a computer network.

9. The system of claim 8, wherein the communication session uses TCP/IP.

10. The system of claim 8, wherein the communication session is a voice-over-Internet protocol session.

11. A method for routing an incoming call from a calling party for a telephone line of a subscriber comprising the steps of:
associating a subscriber number of the subscriber with priority caller information;
storing the subscriber number and the priority caller information in a database;
detecting the incoming call;
consulting the database to determine whether the incoming call comprises the priority caller information; and
executing a priority action if the incoming call comprises the priority caller information,
wherein the priority action comprises one or more of ringing a telephone associated with the telephone line with a priority alert signal that is different from a regular ringing tone; generating an outgoing call to another telephone associated with a second telephone line of the subscriber; generating an outgoing call to a wireless telephone of the subscriber via a wireless telephone network; and establishing a communication session with a computer associated with the subscriber via a computer network.

12. The method of claim 11, wherein the priority caller information is a telephone number associated with a second telephone line that is used to initiate the incoming call.

13. The method of claim 11, wherein the priority caller information is a priority code supplied by the calling party.

14. A method for routing an incoming call from a calling party for a telephone line of a subscriber comprising the steps of:
associating a subscriber number of the subscriber with at least one priority caller number;
storing the subscriber number and the at least one priority caller number in a database;
detecting the incoming call;
consulting the database to determine whether the incoming call comprises the at least one priority caller number; and
executing a priority action if the incoming call comprises the at least one priority caller number.

15. The method of claim 14, wherein the priority action comprises playing a priority alert signal to alert the subscriber to the incoming call.

16. The method of claim 14, wherein the priority action comprises generating at least one outgoing call to one or more telephones associated with the subscriber.

17. The method of claim 14, wherein the priority action comprises generating an outgoing call to a wireless telephone associated with the subscriber via a wireless telephone network.

18. The method of claim 14, wherein the priority action comprises establishing a communication session with a computer associated with the subscriber via a compute r network.

19. The method of claim 18, wherein the communication session uses TCP/IP.

20. The method of claim 18, wherein the communication session uses voice-over-Internet protocol.

21. A method for routing an incoming call from a calling party to a telephone line of a subscriber comprising the steps of:
associating a subscriber number of the subscriber with at least one priority code;
storing the subscriber number and the at least one priority code in a database;
soliciting the calling party for a priority code when the incoming call is received;
receiving the priority code from the calling party;
consulting the database to determine whether the priority code matches any of the at least one priority codes; and
executing a priority action if the priority code matches one of the at least one priority codes.

22. The method of claim 21, wherein the priority action comprises playing a priority alert signal to alert the subscriber to the incoming call.

23. The method of claim 21, wherein the priority action comprises generating at least one outgoing call to one or more telephones associated with the subscriber.

24. The method of claim 21, wherein the priority action comprises generating an outgoing call to a wireless telephone associated with the subscriber via a wireless telephone network.

25. The method of claim 21, wherein the priority action comprises establishing a communication session with a computer associated with the subscriber via a computer network.

26. The method of claim 21, wherein the communication session uses TCP/IP.

27. The method of claim 21, wherein the communication session uses voice-over-Internet protocol.
